(19) United States
(12) Patent Application Publication
(10) Pub. No.: US 2025/0085447 A1
(43) Pub. Date: Mar. 13, 2025

(54) METHOD AND APPARATUS FOR PREDICTING WHILE DRILLING USING SEISMIC AND DRILLING IN TARGET STRATUM

(71) Applicant: China University of Petroleum-Beijing, Beijing City (CN)

(72) Inventors: Sanyi Yuan, Beijing City (CN); Jianxiang Feng, Beijing City (CN); Chao Wu, Beijing City (CN); Haojie Liu, Dongying City (CN); Wenju Sun, Beijing (CN); Shangxu Wang, Beijing City (CN)

(21) Appl. No.: 18/883,365

(22) Filed: Sep. 12, 2024

(30) Foreign Application Priority Data
Sep. 13, 2023 (CN) 202311178198.8

(51) Int. Cl. G01V 1/40

(52) U.S. Cl. CPC G01V 1/40; G01V 2210/6169

(57) ABSTRACT

The present disclosure provides a method and apparatus for predicting while drilling using seismic and drilling data in a target stratum, the method includes: generating depth-domain geological stratification data based on two-dimensional drilling data and one-dimensional logging data to construct a time-depth pairs dictionary; determining a first contribution degree corresponding to GST characteristic attribute data, a second contribution degree corresponding to amplitude energy attribute data and a third contribution degree corresponding to attenuation attribute data, and constructing initial seismic drilling data characterized by a multivariate and multi-type composite attribute; obtaining real-time two-dimensional data while drilling, obtaining an updated first contribution degree, an updated second contribution degree and an updated third contribution degree, and obtaining seismic and drilling prediction data of the target stratum characterized by the multivariate and multi-type composite attribute.

### CROSS-REFERENCE TO RELATED APPLICATIONS

This application claims priority to Chinese Patent Application No. 202311178198.8, filed on Sep. 13, 2023, which is hereby incorporated by reference its entirety.

### TECHNICAL FIELD

The present disclosure relates to the technical field of geological explorations, and particularly, to a method and apparatus for predicting while drilling using seismic and drilling data in a target stratum.

### BACKGROUND

There are very large reserves of oil and gas resources in the carbonate karst rock. In Tarim Basin, the karst reservoirs are deep, the seismic wave velocity is extremely high, and the reservoir spaces are complex, which are mainly secondary dissolution karsts or fractures. The development mode of using one set of Fractured-vuggy Reservoir Zone for one well of an oilfield cannot meet the needs of benefit development, and the “Multi-Targets Directional Drilling” is required in the one well for communication with multiple fractures and caves as much as possible to achieve the needs of benefit development.

Underground karst caves and fractures are not existed in isolation, but have consistent water pressure conditions and independent fractured-vuggy systems, which is called Fractured-vuggy Reservoir Zones. On a post-stack seismic section, karsts are characterized by the string of beads response (SBR) with strong reflection amplitude, small transverse range and obvious longitudinal difference. Usually, the SBR are generally superimposed with the underlying event and noise, which is difficult for identification. In the actual geological exploration, there are many types of SBR. In order to study the formation mechanism of SBR in karst reservoirs of the carbonate rock, numerical and physical models are generally used based on the wave equation numerical simulation and laboratory physical simulation forward response researches. At present, the seismic interpretations of karst reservoirs are mainly classified into two types: the first type includes the traditional identification method of SBR abnormal reflection based on seismic data attributes and an identification method of frequency variation intensity; and the second type is an identification method that extracts SBR abnormal reflection characteristics of karst reservoirs by means of artificial intelligence. However, the existing methods only consider identifying the SBR abnormal reflection formed by seismic diffraction waves, for example using a root mean square amplitude, a wave impedance inversion, a SBR edge detection based on attribute identification, but ignore the attenuation effect of fluid in karst reservoirs on seismic waves, so it is impossible to update karst edge positions in real time in drilling scenarios to optimize the drilling. Moreover, the existing identification methods describe a reservoir from the kinematic characteristic using a singular seismic attribute, without considering the inside information of the reservoir, which leads to strong uncertainty. It cannot accurately identify the karst reservoir boundary, and it is difficult to achieve the safety requirement of “Multi-Targets Directional Drilling” while drilling.

In view of the above problems, no effective solution has been put forward at present.

### SUMMARY

An objective of the present disclosure is to provide a method and apparatus for predicting using seismic and drilling data (e.g. multi-source information) in a target stratum while drilling, which can solve the technical problem of low accuracy in the existing single-attribute prediction of karst reservoirs.

The method and apparatus for predicting while drilling using the seismic and drilling data in the target stratum provided by the present disclosure are implemented as follows.

A method for predicting while drilling using seismic and drilling data in a target stratum, including:
obtaining two-dimensional drilling data (for example, it may be one-dimensional drilling data) and two-dimensional logging data (for example, it may be one-dimensional logging data), and generating depth-domain geological stratification data based on the two-dimensional drilling data and the two-dimensional logging data;
matching the depth-domain geological stratification data with time-domain horizon data to construct a time-depth pairs dictionary;
obtaining three-dimensional seismic data, and extracting Gradient Structure Tensor (GST) characteristic attribute data, amplitude energy attribute data (for example, it may be an arc length) and attenuation attribute data which may be called energy absorption analysis (EEA) from the three-dimensional seismic data;
determining a first contribution degree corresponding to the GST characteristic attribute data, a second contribution degree corresponding to the amplitude energy attribute data and a third contribution degree corresponding to the attenuation attribute data, and constructing initial seismic drilling data characterized by a multivariate and multi-type composite attribute;
obtaining real-time two-dimensional data while drilling (for example, it may be one-dimensional drilling data), and mapping the two-dimensional data while drilling (for example, it may be one-dimensional drilling data) into three-dimensional seismic data while drilling (for example, it may be a three-dimensional seismic data) based on the time-depth pairs dictionary;
updating the first contribution degree, the second contribution degree and the third contribution degree based on the three-dimensional seismic data while drilling that is a weighted expression of the seismic data set consisting of the above three attributes; and
obtaining seismic and drilling prediction data of the target stratum characterized by the multivariate and multi-type composite attribute based on an updated first contribution degree, an updated second contribution degree and an updated third contribution degree.

In an embodiment, the initial seismic drilling data characterized by the multivariate and multi-type composite attribute is expressed as a formula including:

$${R}^{1} = f ( λ ) = A \cdot {λ}_{1}^{1} + B \cdot {λ}_{2}^{1} + C \cdot {λ}_{3}^{1}$$

where, R¹ represents the initial seismic drilling data (that is composite seismic attribute), A represents the GST characteristic attribute data, B represents the amplitude energy attribute data, C represents the attenuation attribute data (EEA), λ₁¹ represents an initial first contribution degree, λ₂¹ represents an initial second contribution degree and λ₃¹ represents an initial third contribution degree.

In an embodiment, updating the first contribution degree, the second contribution degree and the third contribution degree based on the three-dimensional seismic data while drilling includes:
constructing an objective function including:

$$E ( λ ) = {‖ {D}^{n} - f ( {λ}^{n} ) ‖}_{2}^{2}$$

where, Dⁿ represents the three-dimensional seismic data while drilling after an n-th update, and f(λⁿ)=Rⁿ=A·λ₁ⁿ+B·λ₂ⁿ+C·λ₃ⁿ represents the seismic and drilling prediction data characterized by the multivariate and multi-type composite attribute after the n-th update;
solving the objective function using a formula (e.g. solving the objective function using the least squares method) including:

$$λ = {( {S}^{T} S )}^{- 1} {S}^{T} D$$

where, λ represents the first contribution degree, the second contribution degree and the third contribution degree, S represents an l×3 matrix composed of characteristic parameters of the three types of attribute data, and D represents the updated three-dimensional seismic data while drilling of the l×1 matrix; and
taking a solved first contribution degree, a solved second contribution degree and a solved third contribution degree as the updated first contribution degree, the updated second contribution degree and the updated third contribution degree.

In an embodiment, matching the depth-domain geological stratification data with time-domain horizon data to construct a time-depth pairs dictionary includes:
matching a medium stratification initial position through the depth-domain geological stratification data and time-domain horizon data to obtain an initial mapping relationship; and
performing a time-depth conversion based on logging data of an adjacent target stratum and a predicted target stratum average velocity to construct a time-depth pairs dictionary.

In an embodiment, extracting Gradient Structure Tensor (GST) characteristic attribute data from the three-dimensional seismic data includes:
obtaining a gradient vector by calculating first-order partial derivatives of any point u in the three-dimensional seismic data in three directions:

$$g = ∇ u ( x , y , z ) = [ \begin{matrix}\frac{\partial u ( x , y , z )}{\partial x} \\ \frac{\partial u ( x , y , z )}{\partial y} \\ \frac{\partial u ( x , y , z )}{\partial z}\end{matrix} ] = {( {g}_{1} , {g}_{2} , {g}_{3} )}^{T}$$

where, g represents a gradient vector of any point u in the three-dimensional seismic data, and g₁,g₂,g₃ represent partial derivatives of any point u in the three-dimensional seismic data in three directions x, y, z;
constructing a tensor matrix based on the gradient vector:

$${T}_{grad} = {gg}^{T} = ( \begin{matrix}{g}_{1} {g}_{1} & {g}_{1} {g}_{2} & {g}_{1} {g}_{3} \\ {g}_{1} {g}_{2} & {g}_{2} {g}_{2} & {g}_{2} {g}_{3} \\ {g}_{1} {g}_{3} & {g}_{2} {g}_{3} & {g}_{3} {g}_{3}\end{matrix} )$$

performing characteristic decomposition on the tensor matrix to obtain GST characteristic attribute data:

$$T = {γ}_{1} μ {μ}^{T} + {γ}_{2} {vv}^{T} + {γ}_{3} ω {ω}^{T}$$

where, T represents GST characteristic attribute data, γ₁,γ₂,γ₃ represent three eigenvalues of T_{grad}, μ represents a unit bin in a transverse direction x, v represents a unit bin, in a transverse direction y, and ω represents a unit bin in a longitudinal direction z.

In an embodiment, extracting amplitude energy attribute data from the three-dimensional seismic data includes:
extracting a seismic arc length attribute from the three-dimensional seismic data as amplitude energy attribute data based on a following formula including:

$$S = \frac{1}{NT} {\sum }^{N} \sqrt{{[ a ( i + 1 ) - a ( i ) ]}^{2} + {T}^{2}}$$

where, S represents a single-channel seismic arc length extracted from the three-dimensional seismic data, T represents a calculation time window, N represents the number of sampling points in the time window and a(i) represents an amplitude value of an i-th sampling point in the time window.

In an embodiment, extracting attenuation attribute data from the three-dimensional seismic data includes:
extracting attenuation attribute data based on a formula includes:

$$a = u {\vert}_{arctg \frac{{y}_{\_ 85} - {y}_{\_ 65}}{( {f}_{\_ 85} - {f}_{\_ 65} )}}$$

where, represents attenuation attribute data, u represents a current seismic channel amplitude,

$$y = {\sum }_{0}^{n} {A}_{n}$$

represents total energy of seismic channels in the three-dimensional seismic data, f represents a frequency, which is a spectrum of the three-dimensional seismic data determined based on the seismic channel amplitude, y_₈₅ and f_₈₅ represent energy and frequency corresponding to 85% of the total energy, y_₆₅ and f_₆₅ represent energy and frequency corresponding to 65% of the total energy, n represents the number of sampling points and A represents an amplitude value.

An apparatus for predicting while drilling using seismic and drilling data in a target stratum, including:
a first obtainment module configured to obtain two-dimensional drilling data (for example, it may be one-dimensional drilling data) and two-dimensional logging data (for example, it may be one-dimensional logging data), and generate depth-domain geological stratification data based on the two-dimensional drilling data and the two-dimensional logging data;
a matching module configured to match the depth-domain geological stratification data with time-domain horizon to construct a time-depth pairs dictionary;
a second obtainment module configured to obtain three-dimensional seismic data, and extract Gradient Structure Tensor (GST) characteristic attribute data, amplitude energy attribute data (for example, it could also be an arc length and attenuation attribute data which may be called energy absorption analysis (EEA) from the three-dimensional seismic data;
an construction module configured to determine a first contribution degree corresponding to the GST characteristic attribute data, a second contribution degree corresponding to the amplitude energy attribute data and a third contribution degree corresponding to the attenuation attribute data, and construct initial seismic drilling data characterized by a multivariate and multi-type composite attribute;
a third obtainment module configured to obtain real-time two-dimensional data while drilling (for example, it may be one-dimensional drilling data), and map the two-dimensional data while drilling (for example, it may be one-dimensional drilling data) into three-dimensional seismic data while drilling (for example, it may be a three-dimensional seismic data) based on the time-depth pairs dictionary;
an update module configured to update the first contribution degree, the second contribution degree and the third contribution degree based on the three-dimensional seismic data while drilling that is a weighted expression of the seismic data set consisting of the above three attributes; and
a generation module configured to obtain seismic and drilling prediction data of the target stratum represented by the multivariate and multi-type composite attribute based on an updated first contribution degree, an updated second contribution degree and an updated third contribution degree.

An electronic device includes a processor and a memory which stores instructions executable by the processor, and when executing the instructions, the processor implements the steps of the aforementioned method.

A computer-readable storage medium which stores a computer program/instruction therein, and when being executed by a processor, the computer program/instruction implements the steps of the aforementioned method.

The method for predicting while drilling using seismic and drilling data in the target stratum provided by the present disclosure, constructs a seismic and drilling multivariate and multi-type composite attribute obtained by a weighted fusion of two seismic dynamics characteristic attributes and one seismic geometry characteristic attribute, thereby providing an accurate initial prediction result. Then, with the progress of the drilling process, the weight is adjusted in real time based on the update of the drilling data to obtain a finer porous reservoir prediction result. The above solution solves the technical problem of low accuracy in the existing single-attribute prediction of a porous reservoir, and achieves the technical effect of effectively improving the reservoir prediction accuracy and reducing the drilling risk.

### BRIEF DESCRIPTION OF THE DRAWINGS

In order to more clearly describe the technical solutions in the embodiments of the present disclosure or the prior art, the drawings to be used in the descriptions of the embodiments or the prior art will be briefly introduced as follows. Obviously, the drawings in the following descriptions just illustrate some embodiments of the present disclosure, and persons skilled in the art may obtain other drawings from them without paying any creative labor.

FIG. 1 illustrates a flowchart diagram of a method for predicting while drilling using seismic and drilling data in a target stratum according to an embodiment of the present disclosure;

FIG. 2 illustrates a flowchart diagram of a formation of a time-depth pairs dictionary and seismic data preprocessing according to the present disclosure;

FIG. 3 illustrates a flowchart diagram of precisely predicting distributions and properties of karst reservoirs according to the present disclosure;

FIG. 4 illustrates a schematic diagram of a fine calibration of a well trajectory by constructing a time-depth pairs dictionary using an average velocity in target stratum in the adjacent well according to the present disclosure;

FIG. 5 illustrates a schematic diagram of optimally predicting while drilling of a porous reservoir according to the present disclosure;

FIG. 6 illustrates a schematic diagram of drilling in a scalp scraping mode of a “Multi-Targets Directional Drilling” technology according to the present disclosure;

FIG. 7 illustrates a schematic diagram of an optimized drilling solution while drilling in a scalp scraping mode of “Multi-Targets Directional Drilling” according to the present disclosure;

FIG. 8 illustrates a block diagram of a hardware structure of an electronic device for a method for predicting while drilling using seismic and drilling data in a target stratum according to the present disclosure; and

FIG. 9 illustrates a schematic diagram of a module structure diagram of a module for predicting while drilling using seismic and drilling data in a target stratum according to an embodiment of the present disclosure.

### DETAILED DESCRIPTION

In order that persons skilled in the art can better understand the technical solutions in the present disclosure, the technical solutions in the embodiments of the present disclosure will be clearly and completely described with reference to the drawings for the embodiments of the present disclosure. Obviously, those described are just parts, rather than all, of the embodiments of the present disclosure. Any other embodiment obtained by persons skilled in the art based on the embodiments of the present disclosure without paying any creative labor should fall within the protection scope of the present disclosure.

With the exploration of oil and gas resources gradually developing to deep and complex areas, the overpressure areas are progressively increasing, and the development objects are being changed from “single well single karst” to “single well multi-karst” in the case of multiple rounds of oilfield developments, so it is increasingly urgent to realize “Multi-Targets Directional Drilling” while avoiding drilling accidents. In the drilling process of carbonate rock media, it is necessary to predict an accurate reservoir morphology 100 meters in front of a drill bit based on a solution updated by data of the drilled section, which not only prevents the drilling accidents such as circulation loss, venting and well collapse, but also provides references for slurry proportioning in drilling constructions. Therefore, it is necessary to accurately identify the porous reservoir while drilling, so as to communicate multiple fractures and caves as much as possible and control simultaneous exploitation, thus improving the single well controlled reserve scale and single well productivity. Aiming at series fractures and caves in the “scalp wiping” mode, the technology in which the staged acid fracturing completion is used once is adopted, and surface layers of multiple fractured-vuggy bodies are wiped in the “scalp wiping” mode to be transformed one by one to transversely communicate multiple fractured-vuggy bodies and putting into production. This technology requires a high precision in identifying the boundary of Fractured-vuggy Reservoir Zone. If the longitudinal distance is too far from the boundary of Fractured-vuggy Reservoir Zone, it will be difficult to communicate the fractures and caves and the cost of acid fracturing is increased, and if the longitudinal distance is too close, there is a risk of circulation loss in advance. Therefore, it is necessary to identify the karst reservoir with a high precision to avoid drilling accidents and effectively communicate multiple fractured-vuggy bodies, thereby achieving the purposes of safe drilling, economic drilling, cost reduction and productivity increase.

On this basis, the present disclosure proposes a multivariant and multi-type composite attribute based on seismic and drilling data, the composite attribute makes full use of drilling information and seismic dynamics information, considers diffraction wave energy superposition and “SBR” reflection abnormity, and may finely describe reservoir morphologies of different scales based on longitudinal and transverse constraints, so as to improve the certainty of the porous reservoir identification. The composite attribute is obtained by a weighted fusion of two seismic dynamics characteristic attributes and one seismic geometry characteristic attribute, thereby providing an accurate initial prediction result. Then, with the progress of the drilling process, the weight is adjusted in real time based on the updated the drilling data (e.g., drilling time, pressure and hydrocarbon detection) to obtain a finer porous reservoir prediction result (i.e., accurately predicting a karst boundary in front of the drill bit). Based on the prediction result, the drilling may be effectively optimized, multiple fractured-vuggy bodies may be communicated by wiping the surface reservoir bodies, the drilling trajectory may be effectively optimized, and the drilling risk may be reduced, thereby realizing “Multi-Targets Directional Drilling”.

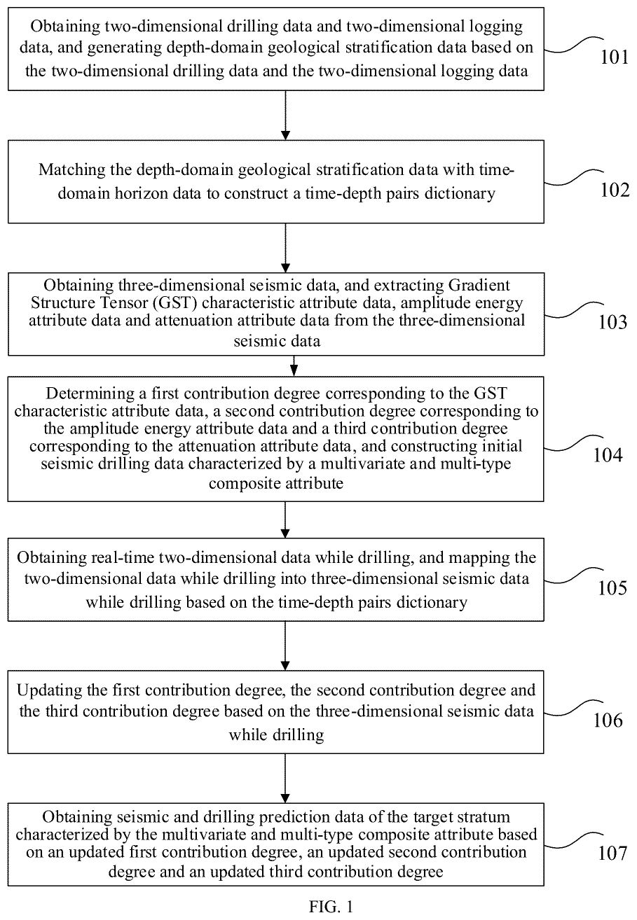

FIG. 1 illustrates a method flowchart diagram of an embodiment of a method for predicting while drilling using seismic and drilling data (e.g. multi-source information) in a target stratum provided by the present disclosure. Although the present disclosure provides method operation steps or apparatus structures in the following embodiments or drawings, more or less operation steps or module units may be included in the method or apparatus based on routine or non-creative labor. In the steps or structures where there is no necessary causal relationship logically, the execution orders of these steps or the modular structures of the apparatus are not limited to those described in the embodiments of the present disclosure or illustrated in the drawings. When being applied to a practical apparatus or terminal product, the methods or the module structures may be executed sequentially or in parallel based on those illustrated in the embodiments or the drawings (e.g., in a parallel processor or a multithreading environment, or even in a distributed processing environment).

Specifically, as illustrated in FIG. 1, a method for predicting while drilling using seismic and drilling data in a target stratum may include the following steps.

Step 101: obtaining two-dimensional drilling data and two-dimensional logging data, and generating depth-domain geological stratification data based on the two-dimensional drilling data and the two-dimensional logging data. For example, two-dimensional drilling data may be one-dimensional drilling data, and the two-dimensional logging data may be one-dimensional logging data.

Step 102: matching the depth-domain geological stratification data with time-domain horizon data to construct a time-depth pairs dictionary.

In this embodiment, matching the depth-domain geological stratification data with time-domain horizon data to construct a time-depth pairs dictionary may include: matching a medium stratification initial position through the geological stratification depth domain data and the time-domain horizon data to obtain an initial mapping relationship; and performing a time-depth conversion based on a predicted target stratum average velocity and logging data of an adjacent target stratum to construct a time-depth pairs dictionary.

In this embodiment, the geological stratification refers to the classification of lithologies in a stratigraphic section of an area, which may be used to optimize the corresponding geological prospecting work, and the lithology is the main basis of the geological stratification. But it is very difficult to judge the geological strata manually, so an automatic stratification technology may be adopted to assist the rapid geological stratification, and for example, a good geological stratification result may be obtained by a BiLSTM network. In this embodiment, a seismic horizon refers to an interface of geological media and is reflected as an event on a seismic section, so it may be interpreted as a geological structure boundary and stored in a time domain format in the seismic data. A fine horizon identification may reduce identification errors, provide accurate geological stratification data in the time domain and improve a drill bit positioning precision. The horizon identification means that an interpreter sparsely interprets a target horizon based on geological sedimentary changes and physical characteristics such as seismic waveform and phase; carries out interpolation, filling encryption based on a waveform similarity, and matches a medium stratification initial position using a fine geological stratification and fine horizon data to obtain an initial mapping relationship; predicts a target stratum average velocity based on logging data of the target stratum in an adjacent well and drilling-time data; and performs a time-depth conversion using the velocity to construct a time-depth pairs dictionary of the target stratum.

Step 103: obtaining three-dimensional seismic data, and extracting Gradient Structure Tensor (GST) characteristic attribute data, amplitude energy attribute data and attenuation attribute data from the three-dimensional seismic data.

In this embodiment, the GST characteristic attribute data may be used to identify a transverse boundary of “SBR” abnormal reflection of post-stack data caused by a seismic wave diffraction; the amplitude energy attribute (e.g., three-dimensional arc length attribute) may characterize an amplitude energy abnormity caused by a strong impedance difference due to the fluid in the porous reservoir; and the attenuation attribute may be used to analyze and obtain a spectral distortion degree caused by the viscous effect of the fluid in the porous reservoir.

Step 104: determining a first contribution degree corresponding to the GST characteristic attribute data, a second contribution degree corresponding to the amplitude energy attribute data and a third contribution degree corresponding to the attenuation attribute data, and constructing initial seismic drilling data characterized by a multivariate and multi-type composite attribute.

Specifically, during implementations, the initial seismic drilling data characterized by the multivariate and multi-type composite attribute may be expressed as:

$${R}^{1} = f ( λ ) = A \cdot {λ}_{1}^{1} + B \cdot {λ}_{2}^{1} + C \cdot {λ}_{3}^{1}$$

where, R¹ represents the initial seismic drilling data, A represents the GST characteristic attribute data, B represents the amplitude energy attribute data (for example, it may be an arc length), C represents the attenuation attribute data called energy absorption analysis (EEA), λ₁¹ represents an initial first contribution degree, λ₂¹ represents an initial second contribution degree and λ₃¹ represents an initial third contribution degree.

Step 105: obtaining real-time two-dimensional data while drilling, and mapping the two-dimensional data while drilling into three-dimensional seismic data while drilling based on the time-depth pairs dictionary. For example, the two-dimensional data while drilling may be one-dimensional data while drilling, and the three-dimensional seismic data while drilling may be a three-dimensional seismic data.

Step 106: updating the first contribution degree, the second contribution degree and the third contribution degree based on the three-dimensional seismic data while drilling. For example, the three-dimensional seismic data while drilling may be a weighted expression of the seismic data set consisting of the above three attributes.

Step 107: obtaining seismic and drilling prediction data of the target stratum characterized by the multivariate and multi-type composite attribute based on an updated first contribution degree, an updated second contribution degree and an updated third contribution degree.

After the seismic and drilling prediction data of the target stratum characterized by the multivariate and multi-type composite attribute is obtained, a karst boundary in front of the drill bit may be predicted, thus accurately guiding the drilling. That is, in the above embodiment, a seismic multi-attribute-based method for predicting while drilling of porous reservoir in a carbonate rock is proposed based on based on the analysis of big data while considering the frequency spectrum changes caused by the karst morphology, the energy change and the fluid viscosity and the three contribution degrees to the porous reservoir updated with the drilling data in real time. By this method, the prediction precision and the resolution of the porous reservoir may be improved, the porous reservoir under the drilling scale may be predicted while drilling, and the porous reservoir of a target stratum in the adjacent well may be finely described based on the current drilling solution, thereby providing accurate guidance for the drilling design and the porous reservoir development in the carbonate rock in future. For e

When updating the first contribution degree, the second contribution degree and the third contribution degree based on the three-dimensional seismic data while drilling, the method may include the following steps:

S1: constructing the following objective function:

$$E ( λ ) = {‖ {D}^{n} - f ( {λ}^{n} ) ‖}_{2}^{2}$$

where, Dⁿ represents the lithological interpretation data derived from well logging data after an n-th update, f(λⁿ)=Rⁿ=A·λ₁ⁿ+B·λ₂ⁿ+C·λ₃ⁿ represents three-dimensional seismic data while drilling characterized by the multivariate and multi-type composite attribute after the n-th update, A represents the GST characteristic attribute data, B represents the amplitude energy attribute data, C represents the attenuation attribute data, λ₁¹ represents an initial first contribution degree, λ₂¹ represents an initial second contribution degree and λ₃¹ represents an initial third contribution degree;
S2: solving the objective function using a formula including:

$$λ = {( {S}^{T} S )}^{- 1} {S}^{T} D$$

where, λ represents the first contribution degree, the second contribution degree and the third contribution degree, S represents an l×3 matrix composed of characteristic parameters of the three types of attribute data, and D represents the updated lithological interpretation data of the l×3 matrix;
S3: taking a solved first contribution degree, a solved second contribution degree and a solved third contribution degree as the updated first contribution degree, the updated second contribution degree and the updated third contribution degree.

The above three attribute data is explained as follows:
1) extracting GST characteristic attribute data from the three-dimensional seismic data may include:
calculating first-order partial derivatives of any point u of the three-dimensional seismic data in three directions:

$$g = ∇ u ( x , y , z ) = [ \begin{matrix}\frac{\partial u ( x , y , z )}{\partial x} \\ \frac{\partial u ( x , y , z )}{\partial y} \\ \frac{\partial u ( x , y , z )}{\partial z}\end{matrix} ] = {( {g}_{1} , {g}_{2} , {g}_{3} )}^{T}$$

where, g represents a gradient vector of any point u in the three-dimensional seismic data, and g₁,g₂,g₃ represent partial derivatives of any point u in the three-dimensional seismic data in three directions x, y, z,
constructing a tensor matrix based on the gradient vector:

$${T}_{grad} = {gg}^{T} = ( \begin{matrix}{g}_{1} {g}_{1} & {g}_{1} {g}_{2} & {g}_{1} {g}_{3} \\ {g}_{1} {g}_{2} & {g}_{2} {g}_{2} & {g}_{2} {g}_{3} \\ {g}_{1} {g}_{3} & {g}_{2} {g}_{3} & {g}_{3} {g}_{3}\end{matrix} )$$

performing characteristic decomposition on the tensor matrix to obtain GST characteristic attribute data:

$$T = {γ}_{1} μ {μ}^{T} + {γ}_{2} {vv}^{T} + {γ}_{3} ω {ω}^{T}$$

where, T represents GST characteristic attribute data, γ₁,γ₂,γ₃ represent three eigenvalues of T_{grad}, μ represents a unit bin in a transverse direction x, v represents a unit bin in a, transverse direction y, and ω represents a unit bin in a longitudinal direction z, and when all elements of T_{grad} are not zero, only one of the three eigenvalues γ₁,γ₂,γ₃ is not zero, so γ=[g]²=g₁²+g₂²+g₃².
2) extracting amplitude energy attribute data from the three-dimensional seismic data may include:
extracting a seismic arc length attribute from the three-dimensional seismic data as amplitude energy attribute data based on a formula including:

$$S = \frac{1}{NT} {\sum }^{N} \sqrt{{[ a ( i + 1 ) - a ( i ) ]}^{2} + {T}^{2}}$$

where, S represents a single-channel seismic arc length extracted from the three-dimensional seismic data, T represents a calculation time window, N represents the number of sampling points in the time window and a(i) represents an amplitude value of an i-th sampling point in the time window.
3) extracting attenuation attribute data from the three-dimensional seismic data may include: extracting attenuation attribute data based on a formula including:

$$a = u {\vert}_{arctg \frac{{y}_{\_ 85} - {y}_{\_ 65}}{( {f}_{\_ 85} - {f}_{\_ 65} )}}$$

where, a represents attenuation attribute data, u represents a current seismic channel amplitude,

$$y = {\sum }_{0}^{n} {A}_{n}$$

represents total energy of seismic channels in the three-dimensional seismic data, f represents a frequency, which is a spectrum of the three-dimensional seismic data determined based on the seismic channel amplitude, y_₈₅ and f_₈₅ represent energy and frequency corresponding to 85% of the total energy, y_₆₅ and f_₆₅ represent energy and frequency corresponding to 65% of the total energy, n represents the number of sampling points and A represents an amplitude value.

The above method is described below with reference to a specific embodiment. However, it should be noted that the specific embodiment is only for better explanation of the present disclosure, and does not constitute any improper limitation thereto.

The reservoir prediction is a very important link in the exploration and development of oil and gas resources. However, due to the special geological properties and complex karst structure of the porous reservoir in the carbonate rock, the existing reservoir prediction methods have certain limitations in precision and accuracy. In this embodiment, in order to improve the accuracy and efficiency of the prediction while drilling of the karst reservoir, different from the existing single attribute identification of the SBR reflection of post-stack data to characterize the porous reservoir, geometry and dynamics sensitive attributes of two metadata (i.e. reflection and diffraction data) of the karsts are mined based on −90° phase-shifted seismic data or relative impedance attributes in junction with characteristics of two type elements (i.e. reflection and diffraction) of seismic wave in the porous reservoir, and it may be determined, through the domain knowledge and big data in conjunction with the application scenarios while drilling, that 1) the GST characteristic attribute data may be used to identify a transverse boundary of SBR abnormal reflection of post-stack data caused by a seismic wave diffraction; 2) the amplitude energy attribute such as the three-dimensional arc length attribute may characterize an amplitude energy abnormity caused by a strong impedance difference due to the fluid in the porous reservoir; and 3) the attenuation attribute may be used to analyze and obtain a spectral distortion degree caused by the viscous effect of the fluid in the karst reservoir. Therefore, it is possible to obtain the seismic composite attributes by fusing the above attributes, so as to accurately predict the karst boundary in front of the well bit, thereby providing high-definition imaging results for the “multi-targets directional drilling” technology. Further, in the actual drilling process, the fused attributes may be corrected in real time based on the drilling data updated in the drilling process, so as to provide new drilling trajectories and predict drilling risks for drilling optimization, realize safe drilling, and lay a basis for efficient production of acid fracturing later, thereby achieving the purpose of increasing the productivity and reducing the cost. A method for precisely predicting distribution and property of a carbonate rock karst reservoir is proposed using a data processing and interpretation algorithm in conjunction with the reservoir characteristic analysis and the model construction, so as to support the drilling construction scheme and effectively predict the construction risk of a well with a measured depth of 100 meters before drilling, and the actual measurement error is less than 15 meters, thereby achieving the purpose of efficient and safe drilling.

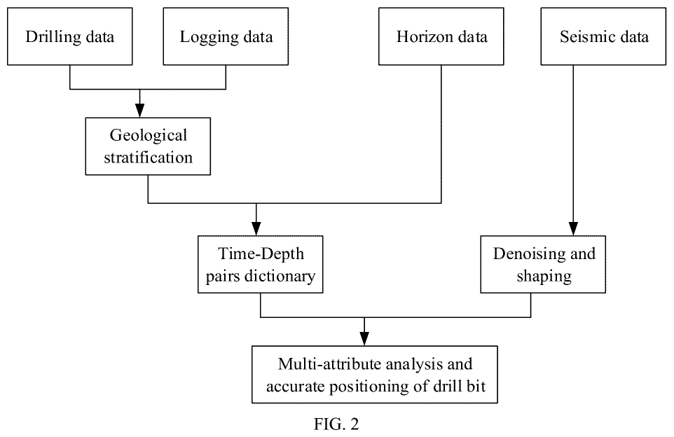

As illustrated in FIG. 2, firstly, the data is properly preprocessed and corrected based on the actual drilling situation, the geological logging data, the logging data, etc.; then, a depth domain fine analysis is carried out on the geological stratification based on the drilling data and the logging data; next, the starting time is accurately matched based on the time domain horizon data of the target stratum; next, a target stratum average velocity is estimated based on the drilling data and the logging data of the target stratum in the adjacent well, and a time-depth relationship dictionary of the target stratum is construction accordingly. Meanwhile, the post-stack seismic data is denoised and shaped to obtain seismic data with a high signal-to-noise ratio and a wide frequency band.

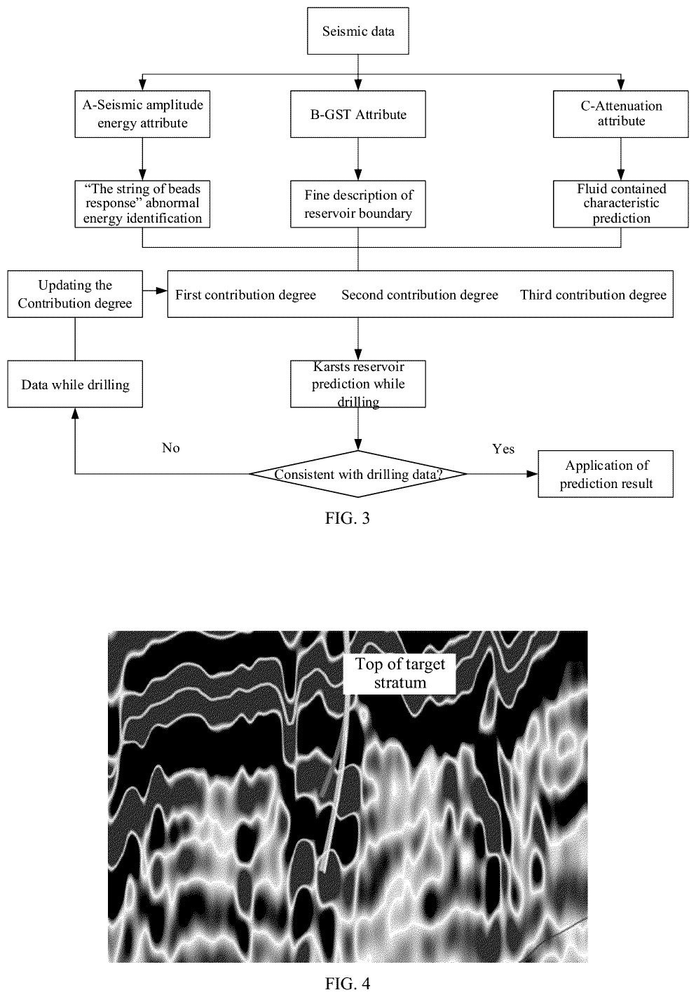

As illustrated in FIG. 3, multiple attributes are calculated for the preprocessed seismic data, including: A. seismic amplitude energy attribute, B. GST characteristic attribute and C. attenuation attribute. In this embodiment, the GST characteristic attribute may be used to finely describe the SBR abnormal morphology and the boundary of geological abnormal bodies; the seismic amplitude energy attribute may be used to identify the amplitude abnormities of “two peaks with one valley” or “three peaks with two valleys” caused by the superposition of diffracted wave energy; and the attenuation attribute may be used to sensitively identify the spectral distortion characteristic of the fluid in the porous reservoir and reveal the inside information of the reservoir. Since the seismic response characteristics of different target karst reservoir bodies are different in the above attributes, it is necessary to analyze the predicted contribution degrees of different attributes in conjunction with the data while drilling. The contribution degree of the GST characteristic attribute data-A is λ₁ⁿ, the contribution degree of seismic amplitude energy attribute-B is λ₂ⁿ, and the contribution degree of the fluid attenuation attribute-C is λ₃ⁿ, in which n represents a serial number of the contribution degree updated with the data while drilling, and the GST characteristic attribute data-A is a seismic dynamics characteristic parameter, which reflects an abnormal concentration of the diffraction superposition energy, and this attribute is calculated in a time window opened in a single channel, thereby ensuring a longitudinal accuracy of a prediction result; the seismic amplitude energy attribute-B is a seismic geometry characteristic parameter, which is a sum of bin eigenvalues of normally transverse direction, thereby providing an accurate transverse constraint of a prediction result; the attenuation attribute-C is a seismic dynamics characteristic parameter, which reflects the attenuation of the seismic wave by the fluid and reveals the inside information of the reservoir, and λ originates from the update of the drilling data.

After the normalization processing, the initial seismic and drilling multivariate and multi-type composite attribute may be expressed as:

$${R}^{1} = f ( λ ) = A \cdot {λ}_{1}^{1} + B \cdot {λ}_{2}^{1} + C \cdot {λ}_{3}^{1} \qquad ( Formula 1 )$$

An l×1 data set obtained by standardized preprocessing of drilling time data, hydrocarbon detection data and pressure data measured during drilling is D, an initial drilling data set is D^{O}, a theoretical value after an n-th update of the drilling data is Dⁿ, and a predicted value is Rⁿ; since it is hoped to find an optimal λ to best adapt data λ=arg minλE(λ), the objective function may be expressed as:

$$E ( λ ) = {‖ {D}^{n} - f ( {λ}^{n} ) ‖}_{2}^{2} \qquad ( Formula 2 )$$

where, E(λ) represents the objective function, and Dⁿ represents the drilling data of the n-th update; f(λⁿ), i.e., Rⁿ=f(λⁿ)=A·λ₁ⁿ+B·λ₂ⁿ+C·λ₃ⁿ, represents the multivariate and multi-type composite attribute in case of the drilling data of the n-th update, in which A represents the GST characteristic attribute data of the standardized seismic dynamic characteristic, B represents the seismic amplitude energy attribute of the standardized seismic geometry characteristic, C represents the attenuation attribute of the standardized seismic dynamics characteristic, λⁿ represents a parameter to be solved for the drilling data of the n-th update, and a least square fitting algorithm is used to solve the above formula to obtain the optimal λ.

In the above algorithm, the seismic multi-type data and the update information of the data while drilling are respectively two seismic dynamics characteristic parameters A and Cone seismic geometry characteristic parameter B and the data while drilling D. The least squares optimization algorithm is adopted for real-time update while drilling, which ensures the accuracy and efficiency of prediction while drilling, and may effectively predict the geological risks within 100 meters in front of the drill bit, so as to correctly select the drilling fluid density and the slurry proportion for efficient, safe and economic drilling, and avoid the risk of circulation loss.

Specifically, the depth-domain geological stratification data is inferred from the drilling data and the logging data, and matched with the time-domain horizon data to establish a time-depth pairs dictionary. The geological stratification refers to the classification of lithologies in a stratigraphic section of an area, which may be used to optimize the corresponding geological prospecting work, and the lithology is the main basis of the geological stratification. But it is very difficult to judge the geological strata manually, so an automatic stratification technology may be adopted to assist the rapid geological stratification, and for example, a good geological stratification result may be obtained by a BiLSTM network.

In this embodiment, a seismic horizon refers to an interface of geological media and is reflected as an event on a seismic section, so it may be interpreted as a geological structure boundary and stored in a time domain format in the seismic data. A fine horizon identification may reduce identification errors, provide accurate geological stratification data in the time domain and improve a drill bit positioning precision. In the existing horizon identification, generally an interpreter sparsely interprets a target horizon based on geological sedimentary changes and physical characteristics such as seismic waveform and phase, and carries out interpolation, filling encryption based on a waveform similarity. Specifically, fine horizon data may be predicted through the network structure model of U-Net.

A fine geological stratification Top and fine horizon data Horizon are used to match the medium stratification initial position to obtain an initial mapping relationship Top [symbol] Horizon₁; then, an average velocity Vₐᵥᵣⁿ of an n-th stratum is predicted based on logging data and drilling time data of the target stratum in an adjacent well; next, the velocity is used to perform a time-depth conversion

$$\frac{\vert TV {D}_{n} - {Top}_{1} \vert}{\vert {Time}_{n} - {hor}_{1} \vert} = {V}_{arv}$$

to establish a time-depth pairs dictionary of the target stratum, in which TVD represents a vertical depth in unit of m; Time represents a seismic sampling point, in unit of ms; Top₁ represents geological well stratification data updated in the drilling, in unit of m; and hor₁ represents seismic horizon data in the time domain, in unit of ms. FIG. 4 illustrates a fine calibration of a well trajectory by constructing a time-depth pairs dictionary using an average velocity in target stratum in the adjacent well. In FIG. 4, a gray thick line denotes an originally designed well trajectory, and a white thick line denotes a well trajectory checkshot_{diet}∝{Time|ₙ^{hor},TVD|ₙ^{top}} finely calibrated with the time-depth pairs dictionary, in which checkshot_{diet} represents a time-depth pairs dictionary, and Time|ₙ^{hor},TVD|ₙ^{top} represent a time domain horizon set and a depth domain well stratification set.

Through the above time-depth pairs dictionary, it can be determined from the trend of a low-frequency background of a transverse change of a geological sedimentary relationship that, in the same sedimentary environment, a stratigraphic framework is stable, and the low-frequency background may be applied to adjacent areas of the same stratum after the high-frequency disturbance caused by micro-tectonic movement or oil and gas reservoir migration is removed. Therefore, the average velocity obtained with the adjacent well may be used for the conversion from large-scale seismic data to small-scale drilling data.

Considering that the seismic reflection characteristics of the karst reservoir will change with the size of karsts, the difference of surrounding rocks and the state of bodies containing fluid, in order to finely describe the porous reservoir and the “SBR” abnormal reflection characteristic and reduce interferences of other geological isomers, in this embodiment, the porous reservoir is described finely with multiple attributes: A. GST characteristic; B. amplitude energy attribute; and C. attenuation attribute, in which:

1) The GST gradient tensor is used to describe the local directional characteristic of a digital image structure, and later is used to extract the discontinuity describing fault development characteristic seismic data from the three-dimensional seismic data to describe the. The seismic data hierarchical structure meets the definition of the GST linear structure, and the GST technology may be used to analyze the seismic data characteristic for seismic interpretation. The calculation of the GST structure characteristic attribute may include: calculating a seismic data gradient; constructing and smoothing a tensor matrix; and decomposing and sorting eigenvalues.

Specifically, a gradient vector may be obtained by calculating first-order partial derivatives of the seismic data in the directions of Time, InLine and CrossLine:
obtaining a gradient vector by calculating first-order partial derivatives of any point u in the three-dimensional seismic data in three directions:

$$g = ∇ u ( x , y , z ) = [ \begin{matrix}\frac{\partial u ( x , y , z )}{\partial x} \\ \frac{\partial u ( x , y , z )}{\partial y} \\ \frac{\partial u ( x , y , z )}{\partial z}\end{matrix} ] = {( {g}_{1} , {g}_{2} , {g}_{3} )}^{T} \qquad ( Formula 3 )$$

where, g represents a gradient vector of any point U in the three-dimensional seismic data, and g₁,g₂,g₃ represent partial derivatives of any point u in the three-dimensional seismic data in three directions x, y, z;
constructing a tensor matrix:

$${T}_{grad} = {gg}^{T} = ( \begin{matrix}{g}_{1} {g}_{1} & {g}_{1} {g}_{2} & {g}_{1} {g}_{3} \\ {g}_{1} {g}_{2} & {g}_{2} {g}_{2} & {g}_{2} {g}_{3} \\ {g}_{1} {g}_{3} & {g}_{2} {g}_{3} & {g}_{3} {g}_{3}\end{matrix} ) \qquad ( Formula 4 )$$

when all elements of T_{grad} are not zero, only one of the three eigenvalues γ₁,γ₂,γ₃ of grad is not zero, then

$$λ = {\vert g \vert}^{2} = {g}_{1}^{2} + {g}_{2}^{2} + {g}_{3}^{2} \qquad ( Formula 5 )$$

For the tensor matrix of any three-dimensional data, characteristic decomposition thereof may be expressed as:

$$T = {λ}_{1} μ {μ}^{T} + {λ}_{2} {vv}^{T} + {λ}_{3} ω {ω}^{T} \qquad ( Formula 6 )$$

where, T represents GST characteristic attribute data, γ₁,γ₂,γ₃ represent three eigenvalues of T_{grad}, μ represents a unit bin in a transverse direction x, V represents a unit bin in a transverse direction y, and ω represents a unit bin in a longitudinal direction z.
2) The amplitude energy attribute (e.g. the seismic arc length attribute) is defined as a seismic waveform length of a seismic trace, which is a ratio-metric measurement of the change range of all the seismic traces within a time window, for a difference between high-amplitude high frequency and high-amplitude low frequency and a difference between low-amplitude high frequency and low-amplitude low frequency, and may be used to distinguish shale sequences from sequences with a high sand content. The calculation formula is as follows:

$$S = \frac{1}{NT} {\sum }^{N} \sqrt{{[ a ( i + 1 ) - a ( i ) ]}^{2} + {T}^{2}} \qquad ( Formula 7 )$$

where, S represents a single-channel seismic arc length extracted from three-dimensional seismic data, T represents a calculation time window, N represents the number of sampling points in the time window and (a)i represents an amplitude value of an i-th sampling point in the time window.
3) The spectral attenuation attribute: for example, if the energy is half-attenuated, a corresponding relative time position is calculated when the energy reaches ½ within a given analysis time window. If the analysis time window is [symbol] , and there are totally N sampling points, the total energy for a seismic data channel X is:

$${E}_{0} = {\sum }_{i = 1}^{N} {( {w}_{i} {x}_{i} )}^{2} \qquad ( Formula 8 )$$

The half-attenuated energy is:

$${E}_{1 / 2} = \frac{{E}_{0}}{2} = {\sum }_{i = 1}^{P} {( {w}_{i} {x}_{i} )}^{2} \qquad ( Formula 9 )$$

The seismic energy change relationship is reflected when the energy is half-attenuated. In a relatively quiet sedimentary environment, the seismic energy change is small and tends to the median value at half-attenuation. If there is oil and gas, while the reflection energy increases, the event is pulled down and energy half-time increases, so the changes of the sedimentary environment, the lithologic map and the lithofacies may be indicated based on the half-attenuated energy.

Alternatively, the attenuation attribute data may also be extracted based on the following formula:

$$a = u {\vert}_{arctg \frac{{y}_{\_ 85} - {y}_{\_ 65}}{( {f}_{\_ 85} - {f}_{\_ 65} )}}$$

where, a represents attenuation attribute data, u represents a current seismic channel amplitude,

$$y = {\sum }_{0}^{n} {A}_{n}$$

represents total energy of seismic channels in the three-dimensional seismic data, f represents a frequency, which is a spectrum of the three-dimensional seismic data determined based on the seismic channel amplitude, y_₈₅ and f_₈₅ represent energy and frequency corresponding to 85% of the total energy, y_₆₅ and f_₆₅ represent energy and frequency corresponding to 65% of the total energy, n represents the number of sampling points and A represents an amplitude value.

In this embodiment, the drilling and seismic multivariate and multi-type data is used to comprehensively determine the porous reservoir and update the contribution degree of each attribute in real time while drilling, so as to finely describe reservoir morphology and optimize the drilling. Since the seismic response characteristics of different karst reservoir bodies are different in the above attributes, it is necessary to analyze the predicted contribution degrees of different attributes in conjunction with the data while drilling. The contribution degree of the GST characteristic attribute data-A is λ₁ⁿ, the contribution degree of the seismic amplitude energy attribute data-B is λ₂ⁿ, and the contribution degree of the fluid attenuation attribute-C is λ₃ⁿ, in which n represents a serial number of the contribution degree updated with the data while drilling, and the GST characteristic attribute data-A is a seismic dynamics characteristic parameter, which reflects an abnormal concentration of the diffraction superposition energy, and this attribute is calculated in a time window opened in a single channel, thereby ensuring a longitudinal accuracy of a prediction result; the seismic amplitude energy attribute data-B is a seismic geometry characteristic parameter, which is a sum of bin eigenvalues of normally transverse direction, thereby providing an accurate transverse constraint of a prediction result; the fluid attenuation attribute-C is a seismic dynamics characteristic parameter, which reflects the attenuation of the seismic wave by the fluid and reveals the inside information of the reservoir, and λ originates from the update of the drilling data.

After normalization, the initial seismic and drilling multivariate and multi-type composite attribute may be expressed as:

$${R}^{1} = f ( λ ) = A \cdot {λ}_{1}^{1} + B \cdot {λ}_{2}^{1} + C \cdot {λ}_{3}^{1} \qquad ( Formula 10 )$$

An l×1 data set obtained by standardized preprocessing of drilling time data, hydrocarbon detection data and pressure data measured during drilling is D, an initial drilling data set is D^{O}, a theoretical value after an n-th update of the drilling data is Dⁿ, and a predicted value is Rⁿ; since it is hoped to find an optimal λ to best adapt data λ=arg min_{λ}E(λ), the objective function may be expressed as:

$$E ( λ ) = {‖ {D}^{n} - f ( {λ}^{n} ) ‖}_{2}^{2} \qquad ( Formula 11 )$$

where, E(λ) represents the objective function, and Dⁿ represents the drilling data of the n-th update; f(λⁿ), i.e., Rⁿ=f(λⁿ)=A·λ₁ⁿ+B·λ₂ⁿ+C·λ₃ⁿ, represents the multivariate and multi-type composite attribute in case of the drilling data of the n-th update, in which A represents the GST characteristic attribute data of the standardized seismic dynamic characteristic, B represents the amplitude energy attribute data of the standardized seismic geometry characteristic, C represents the attenuation attribute of the standardized seismic dynamics characteristic, and λⁿ represents a parameter to be solved for the drilling data of the n-th update.

The least square fitting algorithm is used to calculate an optimal solution of Formula 11, which may be rewritten as:

$$S \cdot λ = D \qquad ( Formula 12 )$$

The least square solution is:

$$λ = {( {S}^{T} S )}^{- 1} {S}^{T} D \qquad ( Formula 13 )$$

where, λ represents a weight parameter to be solved; for example, in a single channel calculation, S represents an l×3 matrix composed of three characteristic parameters, and D represents a theoretical value obtained from the updated data of l×1 while drilling.

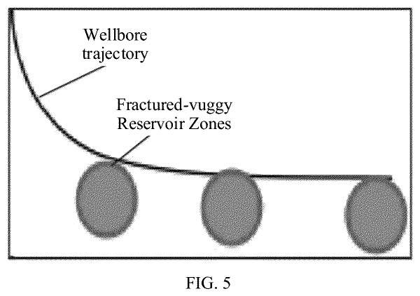

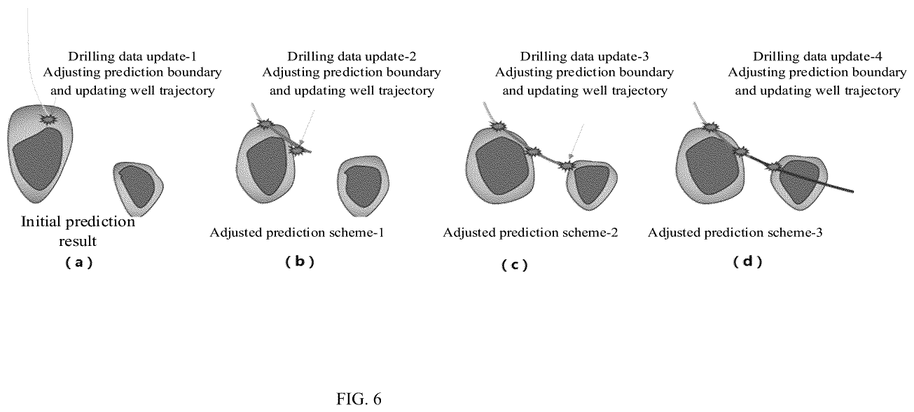

FIG. 5 illustrates schematic diagram of optimally predicting while drilling of a porous reservoir, i.e., a wellbore trajectory passes over the side of a fracture-cave body. FIG. 6 illustrates a schematic diagram of drilling in a scalp scraping mode of a “Multi-Targets Directional Drilling” technology in this embodiment, in which with the update of the drilling data, the reservoir body prediction results are continuously finely adjusted to predict the drilling risk, and after the drilling data is updated, the prediction boundary is adjusted and the well trajectory is updated. That is, (a) of FIG. 6 illustrates an initial prediction result, (b) of FIG. 6 illustrates an adjusted prediction scheme-1, (c) of FIG. 6 illustrates an adjusted prediction scheme-2, and (d) of FIG. 6 illustrates an adjusted prediction scheme-3.

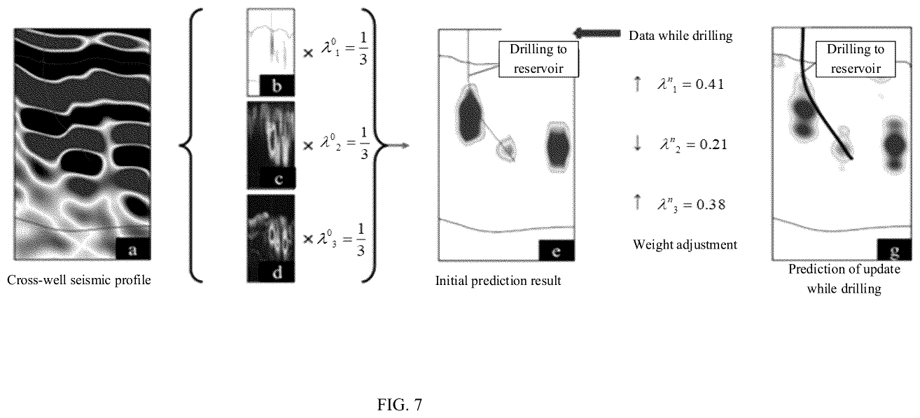

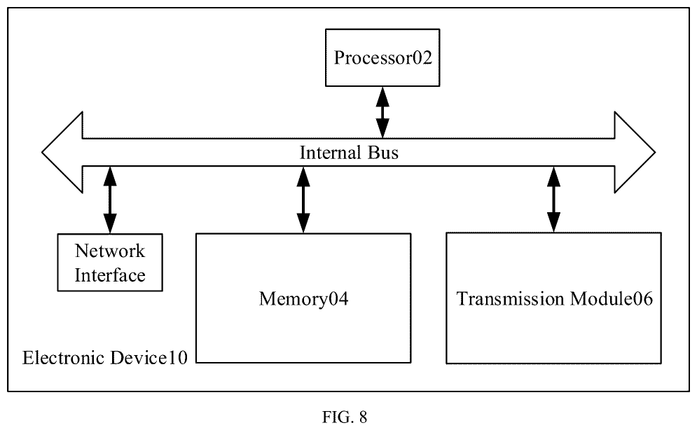

FIG. 7 illustrates a schematic diagram of an optimized drilling solution while drilling in a scalp scraping mode of “Multi-Targets Directional Drilling” and illustrates a comparison schematic diagram of a seismic physical simulation section, labels and prediction results, in which a illustrates a porous seismic physical simulation section, b, c and d illustrate three attribute labels, e illustrates an initial prediction result, and g illustrates an updated prediction result while drilling; an initial multivariate and multi-type composite attribute

$$λ = [ \frac{1}{3} , \frac{1}{3} , \frac{1}{3} ]$$

is updated by least square fitting based on drilling time and total hydrocarbon detection data while drilling to obtain λⁿ=[0.41,0.21,0.38] thereby obtaining an updated prediction result while drilling.

In the above embodiment, the seismic multi-type data and the update information of the data while drilling is considered, i.e., two seismic dynamics characteristic parameters A and C, one seismic geometry characteristic parameter B and the data while drilling D. The least squares optimization algorithm is adopted for real-time update while drilling, which ensures the accuracy and efficiency of prediction while drilling, and may effectively predict the geological risks within 100 meters in front of the drill bit, so as to correctly select the drilling fluid density and the slurry proportion for efficient, safe and economic drilling, and avoid the risk of circulation loss. The carbonate rock karst reservoir is comprehensively and finely described with the multivariate and multi-type composite attribute, and compared with the existing single-attribute description of the SBR abnormity of the karst reservoir, the present disclosure considers the combination of the seismic data and the drilling data at different scales, the multi-type data fusion of the seismic dynamics characteristic and the seismic geometry characteristic, and the influence of the diffraction superposition, the SBR abnormal reflection and the inside information of the reservoir on the reservoir identification. By using the seismic transverse constraint of the GST characteristic attribute and the longitudinal constraint of the amplitude energy attribute, the certainty of the small-scale porous reservoir is strengthened and the prediction errors of the large-scale caves are reduced. The least square fitting is adopted to efficiently and dynamically process the drilling information obtained while drilling, and update the weight of each attribute to the description of the karst reservoir in real time. During exploratory drilling, the fine prediction of the reservoir while drilling may be realized, so as to optimize drilling and achieve safe and economical drilling.

The above method embodiment of the present disclosure may be performed in a mobile terminal, a computer terminal or a similar computing apparatus. Taking an electronic device as an example, FIG. 8 illustrates a block diagram of a hardware structure of an electronic device for a method for predicting while drilling using seismic and drilling data in a target stratum provided by the present disclosure. As illustrated in FIG. 8, the electronic device 10 may include one or more (only one is illustrated) processors 02 (including but not limited to a processing device such as a microprocessor MCU or a programmable logic device FPGA), a memory 04 configured to store data, and a transmission module 06 for a communication function. Those of ordinary skill in the art may understand that the structure illustrated in FIG. 8 is only schematic, rather than limiting the structure of the above electronic device. For example, the electronic device 10 may further include components more or fewer than those illustrated in FIG. 8, or have a configuration different from that illustrated in FIG. 8.

The memory 04 may be configured to store software programs and modules of application software, such as program instructions/modules corresponding to the method for predicting while drilling using seismic and drilling data in the target stratum in the embodiment of the present disclosure. The processor 02 executes various functional applications and data processing by running the software programs and the modules stored in the memory 04, i.e., implementing the method for predicting while drilling using seismic and drilling data in the target stratum of the above application program. The memory 04 may include a high-speed random-access memory, and may further include a non-volatile memory such as one or more magnetic storage devices, a flash memory, or any other non-volatile solid-state memory. In some examples, the memory 04 may further include memories remotely set relative to the processor 02, and these remote memories may be connected to the electronic device 10 via a network, examples of which include, but are not limited to, the Internet, an intranet, a local area network, a mobile communication network, and combinations thereof.

The transmission module 06 is configured to receive or transmit data via a network. The specific example of the network may include a wireless network provided by a communication provider of the electronic device 10. In an example, the transmission module 06 includes a Network Interface Controller (NIC), which is connected to any other network device through a base station so as to be communicated with the Internet. In an example, the transmission module 06 may be a Radio Frequency (RF) module, which is wirelessly communicated with the Internet.

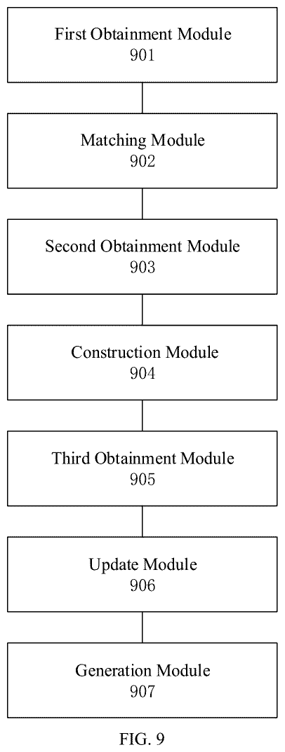

On the software level, an apparatus for predicting while drilling using seismic and drilling data in the target stratum may be as illustrated in FIG. 9, including:
a first obtainment module 901 configured to obtain two-dimensional drilling data and two-dimensional logging data, and generate depth-domain geological stratification data based on the two-dimensional drilling data (for example, it may be one-dimensional drilling data) and the two-dimensional logging data (for example, it may be one-dimensional logging data);
a matching module 902 configured to match the depth-domain geological stratification data with time-domain horizon data to construct a time-depth pairs dictionary;
a second obtainment module 903 configured to obtain three-dimensional seismic data, and extract GST characteristic attribute data, amplitude energy attribute data (for example, it may be an arc length) and attenuation attribute data which may be called energy absorption analysis (EEA) from the three-dimensional seismic data;
an construction module 904 configured to determine a first contribution degree corresponding to the GST characteristic attribute data, a second contribution degree corresponding to the amplitude energy attribute data and a third contribution degree corresponding to the attenuation attribute data, and construct initial seismic drilling data characterized by a multivariate and multi-type composite attribute;
a third obtainment module 905 configured to obtain real-time two-dimensional data while drilling (for example, it may be one-dimensional drilling data), and map the two-dimensional data while drilling (for example, it may be one-dimensional drilling data) into three-dimensional seismic data while drilling (for example, it may be a three-dimensional seismic data) based on the time-depth pairs dictionary;
an update module 906 configured to update the first contribution degree, the second contribution degree and the third contribution degree based on the three-dimensional seismic data while drilling that is determined by three attributes and lithological interpretations derived from well logging data; and
a generation module 907 configured to obtain the seismic and drilling prediction data of the target stratum represented by the multivariate and multi-type composite attribute based on an updated first contribution degree, an updated second contribution degree and an updated third contribution degree which have been updated.

In an embodiment, the initial seismic drilling data characterized by the multivariate and multi-type composite attribute may be expressed as:

$${R}^{1} = f ( λ ) = A \cdot {λ}_{1}^{1} + B \cdot {λ}_{2}^{1} + C \cdot {λ}_{3}^{1}$$

where, R¹ represents the initial seismic drilling data (that is composite seismic attribute), A represents the GST characteristic attribute data, B represents the amplitude energy attribute data, C represents the attenuation attribute data (EEA), λ₁¹ represents an initial first contribution degree, λ₂¹ represents an initial second contribution degree and λ₃¹ represents an initial third contribution degree.

In an embodiment, the update module 906 may specifically construct the following objective function:

$$E ( λ ) = {‖ {D}^{n} - f ( {λ}^{n} ) ‖}_{2}^{2}$$

where, Dⁿ represents the lithological interpretation data derived from well logging data after an n-th update, and f(λⁿ)=Rⁿ=A·λ₁ⁿ+B·λ₂ⁿ+C·λ₃ⁿ represents the three-dimensional seismic data while drilling characterized by the multivariate and multi-type composite attribute after the n-th update;
the objective function is solved using the following formula (e.g. solving the objective function using the least squares method):

$$λ = {( {S}^{T} S )}^{- 1} {S}^{T} D$$

where, λ represents the first contribution degree, the second contribution degree and the third contribution degree, S represents an l×3 matrix composed of characteristic parameters of the three types of attribute data, and D represents the lithological interpretation data of the l×1 matrix; and
a solved first contribution degree, a solved second contribution degree and a solved third contribution degree are taken as the updated first contribution degree, the updated second contribution degree and the updated third contribution degree.

In an embodiment, the matching module 902 may specifically match a medium stratification initial position through geological stratification depth domain data and time-domain horizon data to obtain an initial mapping relationship; and perform a time-depth conversion based on logging data of an adjacent target stratum and a predicted target stratum average velocity to construct a time-depth pairs dictionary.

In an embodiment, the second obtainment module 903 may specifically obtain a gradient vector by calculating first-order partial derivatives of any point u in the three-dimensional seismic data in three directions:

$$g = ∇ u ( x , y , z ) = [ \begin{matrix}\frac{\partial u ( x , y , z )}{\partial x} \\ \frac{\partial u ( x , y , z )}{\partial y} \\ \frac{\partial u ( x , y , z )}{\partial z}\end{matrix} ] = {( {g}_{1} , {g}_{2} , {g}_{3} )}^{T}$$

where, g represents a gradient vector of any point u in the three-dimensional seismic data, and g₁,g₂,g₃ represent partial derivatives of any point u in the three-dimensional seismic data in three directions x, y, z;
construct a tensor matrix based on the gradient vector:

$${T}_{grad} = {gg}^{T} = ( \begin{matrix}{g}_{1} {g}_{1} & {g}_{1} {g}_{2} & {g}_{1} {g}_{3} \\ {g}_{1} {g}_{2} & {g}_{2} {g}_{2} & {g}_{2} {g}_{3} \\ {g}_{1} {g}_{3} & {g}_{2} {g}_{3} & {g}_{3} {g}_{3}\end{matrix} )$$

perform characteristic decomposition on the tensor matrix to obtain GST characteristic attribute data:

$$T = {γ}_{1} {μμ}^{T} + {γ}_{2} {νν}^{T} + {γ}_{3} {ωω}^{T}$$

where, T represents GST characteristic attribute data, γ₁,γ₂,γ₃ represent three eigenvalues of T_{grad}, μ represents a unit bin in a transverse direction x, v represents a unit bin in a transverse direction y, and ω represents a unit bin in a longitudinal direction z.

In an embodiment, the second obtainment module 903 may specifically extract a seismic arc length attribute from the three-dimensional seismic data as amplitude energy attribute data based on the following formula:

$$S = \frac{1}{N T} {\sum }^{N} \sqrt{{[ a ( i + 1 ) - a ( i ) ]}^{2} + {T}^{2}}$$

where, S represents a single-channel seismic arc length extracted from the three-dimensional seismic data, T represents a calculation time window, N represents the number of sampling points in the time window and a(i) represents an amplitude value of an i-th sampling point in the time window.

In an embodiment, the second obtainment module 903 may specifically extract the attenuation attribute data based on the following formula:

$${a = u \vert}_{a r c t g \frac{{y}_{\_ 85} - {y}_{\_ 65}}{( {f}_{\_ 85} - {f}_{\_ 65} )}}$$

where, a represents attenuation attribute data, u represents a current seismic channel amplitude,

$$y = {\sum }_{0}^{n} {A}_{n}$$

represents total energy of seismic channels in the three-dimensional seismic data, f represents a frequency, which is a spectrum of the three-dimensional seismic data determined based on the seismic channel amplitude, y_₈₅ and f_₈₅ represent energy and frequency corresponding to 85% of the total energy, y_₆₅ and f_₆₅ represent energy and frequency corresponding to 65% of the total energy, n represents the number of sampling points and A represents an amplitude value.

The embodiments of the present disclosure also provide an implementation of an electronic device which may implement all the steps in the method for predicting while drilling using seismic and drilling data in the target stratum in the above embodiments, and the electronic device specifically includes: a processor, a memory, a communications interface and a bus; in which the processor, the memory and the communication interface are communicated with each other through the bus; the processor is configured to call a computer program in the memory, and when executing the computer program, the processor implements all the steps in the method for predicting while drilling using seismic and drilling data in the target stratum in the above embodiments. For example, when executing the computer program, the processor implements the following steps:
Step 1: obtaining two-dimensional drilling data and two-dimensional logging data, and generating depth-domain geological stratification data based on the two-dimensional drilling data and the two-dimensional logging data;
Step 2: matching the depth-domain geological stratification data with time-domain horizon data to construct a time-depth pairs dictionary;
Step 3: obtaining three-dimensional seismic data, and extracting Gradient Structure Tensor (GST) characteristic attribute data, amplitude energy attribute data and attenuation attribute data from the three-dimensional seismic data;
Step 4: determining a first contribution degree corresponding to the GST characteristic attribute data, a second contribution degree corresponding to the amplitude energy attribute data and a third contribution degree corresponding to the attenuation attribute data, and constructing initial seismic drilling data characterized by a multivariate and multi-type composite attribute;
Step 5: obtaining real-time two-dimensional data while drilling, and mapping the two-dimensional data while drilling into three-dimensional seismic data while drilling based on the time-depth pairs dictionary;
Step 6: updating the first contribution degree, the second contribution degree and the third contribution degree based on the three-dimensional seismic data while drilling;
Step 7: obtaining seismic and drilling prediction data of the target stratum characterized by the multivariate and multi-type composite attribute based on an updated first contribution degree, an updated second contribution degree and an updated third contribution degree.

The embodiments of the present disclosure also provide an implementation of a computer-readable storage medium which may implement all the steps in the method for predicting while drilling using seismic and drilling data in the target stratum in the above embodiments, and a computer program is stored in the computer-readable storage medium, and when being executed by a processor, the computer program implements all the steps in the method for predicting while drilling using seismic and drilling data in the target stratum in the above embodiments. For example, when being executed by the processor, the computer program implements following steps:
Step 1: obtaining two-dimensional drilling data and two-dimensional logging data, and generating depth-domain geological stratification data based on the two-dimensional drilling data and the two-dimensional logging data;
Step 2: matching the depth-domain geological stratification data with time-domain horizon data to construct a time-depth pairs dictionary;
Step 3: obtaining three-dimensional seismic data, and extracting Gradient Structure Tensor (GST) characteristic attribute data, amplitude energy attribute data and attenuation attribute data from the three-dimensional seismic data;
Step 4: determining a first contribution degree corresponding to the GST characteristic attribute data, a second contribution degree corresponding to the amplitude energy attribute data and a third contribution degree corresponding to the attenuation attribute data, and constructing initial seismic drilling data characterized by a multivariate and multi-type composite attribute;
Step 5: obtaining real-time two-dimensional data while drilling, and mapping the two-dimensional data while drilling into three-dimensional seismic data while drilling based on the time-depth pairs dictionary;
Step 6: updating the first contribution degree, the second contribution degree and the third contribution degree based on the three-dimensional seismic data while drilling;
Step 7: obtaining seismic and drilling prediction data of the target stratum characterized by the multivariate and multi-type composite attribute based on an updated first contribution degree, an updated second contribution degree and an updated third contribution degree.

As can be seen from the above description, the embodiments of the present disclosure construct a seismic and drilling multivariate and multi-type composite attribute, the composite attribute is obtained by a weighted fusion of two seismic dynamics characteristic attributes and one seismic geometry characteristic attribute, thereby providing an accurate initial prediction result. Then, with the progress of the drilling process, the weight is adjusted in real time based on the update of the drilling data to obtain a finer porous reservoir prediction result. The above solution solves the technical problem of low accuracy in the existing single-attribute prediction of a porous reservoir, and achieves the technical effect of effectively improving the reservoir prediction accuracy and reducing the drilling risk.

The embodiments herein are described in a progressive manner, and the same or similar parts of the embodiments can refer to each other. Each embodiment lays an emphasis on its distinctions from other embodiments. In particular, an embodiment of hardware plus program is simply described since it is substantially similar to the method embodiment, and please refer to the description of the method embodiment for the relevant portion.

The specific embodiments of the present disclosure have been described above, and other embodiments are within the scope of the appended claims. In some cases, the actions or steps recited in the claims may be performed in a different order than in the embodiments and still achieve the desired results. In addition, the processes depicted in the drawings do not necessarily require a specific order illustrated or a consecutive order to achieve the desired results. In some embodiments, multitasking and parallel processing are also possible or may be advantageous.

Although the present disclosure provides the methodical operation steps as described in the embodiments or the flowcharts, more or fewer operation steps may be included based on the conventional or non-inventive labor. The step execution order listed in the embodiments is only one of many step execution orders and does not represent a unique execution order. In case of an actual device or terminal product, the steps may be executed orderly or in parallel (e.g., by the parallel processors, or under a multi-thread processing environment) according to the method illustrated in the embodiments or the drawings.

Although the embodiments of the present disclosure provide methodical operation steps as described in the embodiments or the flowcharts, more or fewer operation steps may be included based on the conventional or non-inventive means. The step execution order listed in the embodiments is only one of many step execution orders and does not represent a unique execution order. In case of an actual device or terminal product, the steps may be executed orderly or in parallel (e. g., by the parallel processors, or under a multi-thread processing environment or even a distributed data processing environment) according to the method illustrated in the embodiments or the drawings. The term ‘comprise’, ‘include’ or any other variant is intended to cover the non-exclusive inclusions, so that a process, a method, a product or a device including a series of elements include not only those elements, but also other elements not explicitly listed, or further include inherent elements of such process, method, product or device. In a case where there is no further limitation, it is not excluded that there are other identical or equivalent elements in the process, method, product or device including the above elements.

For the convenience of description, the apparatus is described based on the functions through various functional modules, respectively. Of course, during implementation of the embodiments of the present disclosure, the functions of the modules may be implemented in the same or a plurality of software and/or hardware, or a module that implements a function may be implemented by a combination of a plurality of submodules or subunits, and the like. The apparatus embodiments described above are merely illustrative, e.g., the unit partitioning is only a logical function partitioning, and other partitioning modes are possible during the actual implementation. For example, a plurality of units or components may be combined or integrated into another system, or some features may be omitted or not executed. In addition, the mutual coupling or direct coupling or communication connection illustrated or discussed may be an indirect coupling or communication connection through some interfaces, devices or units, and may be in electrical, mechanical or other forms.

The present disclosure is described with reference to a flowchart and/or a block diagram of the method, device (system) and computer program product according to the embodiments of the present disclosure. It shall be appreciated that a combination of each flow and/or block in the flowchart and/or the block diagram and flows and/or blocks in the flowchart and/or the block diagram may be implemented by computer program instructions. Those computer program instructions may be provided to a general computer, a dedicated computer, an embedded processor or a processor of other programmable data processing device to produce a machine, so that the instructions executed by the processor of the computer or other programmable data processing device produce device for implementing specified functions in one or more flows in the flowchart and/or one or more blocks in the block diagram.

These computer program instructions may also be stored in a computer readable memory capable of guiding the computer or other programmable data processing devices to work in a particular manner, so that the instructions stored in the computer readable memory can produce manufacture articles including an instructing device which implements function(s) specified in one or more flows in the flowchart and/or one or more blocks in the block diagram.

These computer program instructions may also be loaded onto the computer or other programmable data processing devices, so that a series of operation steps are performed on the computer or other programmable data processing devices to produce a processing implemented by the computer, thus the instructions executed on the computer or other programmable devices provide step(s) for implementing function(s) specified in one or more flows in the flowchart and/or one or more blocks in the block diagram.

Those skilled in the art should appreciate that any one embodiment of the present disclosure can be provided as a method, a system or a computer program product. Therefore, the present disclosure can take the form of a full hardware embodiment, a full software embodiment, or an embodiment combining software and hardware. Moreover, the present disclosure can take the form of a computer program product implemented on one or more computer usable storage mediums (including, but not limited to, a magnetic disc memory, CD-ROM, optical storage, etc.) containing therein computer usable program codes.

The embodiments of the present disclosure may be described in the general context of computer executable instructions executed by the computer, e.g., the program module. In general, the program module includes routine, program, object, component, data structure, etc. executing a particular task or implementing a particular abstract data type. The embodiments of the present disclosure may also be put into practice in the distributed computing environments where tasks are executed by remote processing devices connected through a communication network. In the distributed computing environments, the program modules may be located in the local and remote computer storage medium including the storage device.

The embodiments of the present disclosure are all described in a progressive manner, and the same or similar portions of the embodiments can refer to each other. Each embodiment lays an emphasis on its distinctions from other embodiments. In particular, the system embodiment is simply described since it is substantially similar to the method embodiment, and please refer to the descriptions of the method embodiment for the relevant parts. In the description of the present disclosure, the description of reference terms ‘an embodiment’, ‘some embodiments’, ‘an example’, ‘a specific example’ or ‘some examples’ and the like mean that the specific features, structures, materials, or characteristics described in conjunction with the embodiment(s) or example(s) are included in at least one embodiment or example of the present disclosure. In the present disclosure, the schematic expressions of the above terms do not necessarily aim at the same embodiment or example. Moreover, the specific features, structures, materials, or characteristics described may be combined in any one or more embodiments or examples in a suitable manner. In addition, those skilled in the art may combine different embodiments or examples described in the present disclosure and features thereof if there is no contradiction.

Those described above are just examples of the embodiments of the present disclosure, rather than limitations thereto. For those skilled in the art, the embodiments of the present disclosure may have various amendments or variations. Any amendment, equivalent substitution, improvement, etc. within the spirit and principle of the present disclosure should fall within the scope of the claims.

What is claimed is:

1. A method for predicting while drilling using seismic and drilling data in a target stratum, comprising:
obtaining two-dimensional drilling data and two-dimensional logging data, and generating depth-domain geological stratification data based on the two-dimensional drilling data and the two-dimensional logging data;
matching the depth-domain geological stratification data with time-domain horizon data to construct a time-depth pairs dictionary;
obtaining three-dimensional seismic data, and extracting Gradient Structure Tensor (GST) characteristic attribute data, amplitude energy attribute data and attenuation attribute data from the three-dimensional seismic data;
determining a first contribution degree corresponding to the GST characteristic attribute data, a second contribution degree corresponding to the amplitude energy attribute data and a third contribution degree corresponding to the attenuation attribute data, and constructing initial seismic drilling data characterized by a multivariate and multi-type composite attribute;
obtaining real-time two-dimensional data while drilling, and mapping the two-dimensional data while drilling into three-dimensional seismic data while drilling based on the time-depth pairs dictionary;
updating the first contribution degree, the second contribution degree and the third contribution degree based on the three-dimensional seismic data while drilling; and
obtaining seismic and drilling prediction data of the target stratum characterized by the multivariate and multi-type composite attribute based on an updated first contribution degree, an updated second contribution degree and an updated third contribution degree.

2. The method according to claim 1, wherein the initial seismic drilling data characterized by the multivariate and multi-type composite attribute is expressed as a formula comprising:
$${R}^{1} = f ( λ ) = A \cdot {λ}_{1}^{1} + B \cdot {A}_{2}^{1} + C \cdot {λ}_{3}^{1}$$
where, R¹ represents the initial seismic drilling data, A represents the GST characteristic attribute data, B represents the amplitude energy attribute data, C represents the attenuation attribute data, λ₁¹ represents an initial first contribution degree, λ₂¹ represents an initial second contribution degree and λ₃¹ represents an initial third contribution degree.

3. The method according to claim 2, wherein updating the first contribution degree, the second contribution degree and the third contribution degree based on the three-dimensional seismic data while drilling comprises:
constructing an objective function comprising:
$$E ( λ ) = {‖ {D}^{n} - f ( {λ}^{n} ) ‖}_{2}^{2}$$
where, Dⁿ represents the lithological interpretation data derived from well logging data after an n-th update, and f(λⁿ)=Rⁿ=A·λ₁ⁿ+B·λ₂ⁿ+C·λ₃ⁿ represents the three-dimensional seismic data while drilling characterized by the multivariate and multi-type composite attribute after the n-th update;
solving the objective function using a formula comprising:
$$λ = {( {S}^{T} S )}^{- 1} {S}^{T} D$$
where, λ represents the first contribution degree, the second contribution degree and the third contribution degree, S represents an l×3 matrix composed of characteristic parameters of the three types of attribute data, and D represents the updated lithological interpretation data of the l×3 matrix; and
taking a solved first contribution degree, a solved second contribution degree and a solved third contribution degree as the updated first contribution degree, the updated second contribution degree and the updated third contribution degree.

4. The method according to claim 1, wherein matching the depth-domain geological stratification data with time-domain horizon data to construct a time-depth pairs dictionary comprises:
matching a medium stratification initial position through the geological stratification depth domain data and time-domain horizon data to obtain an initial mapping relationship; and
performing a time-depth conversion based on logging data of an adjacent target stratum and a predicted target stratum average velocity to construct a time-depth pairs dictionary.

5. The method according to claim 1, wherein extracting Gradient Structure Tensor (GST) characteristic attribute data from the three-dimensional seismic data comprises:
obtaining a gradient vector by calculating first-order partial derivatives of any point u in the three-dimensional seismic data in three directions:
$$g = ∇ u ( x , y , z ) = [ \begin{matrix}\frac{\partial u ( x , y , z )}{\partial x} \\ \frac{\partial u ( x , y , z )}{\partial y} \\ \frac{\partial u ( x , y , z )}{\partial z}\end{matrix} ] = {( {g}_{1} , {g}_{2} , {g}_{3} )}^{T}$$
where, g represents a gradient vector of any point u in the three-dimensional seismic data, and g₁,g₂,g₃ represent partial derivatives of any point u in the three-dimensional seismic data in three directions x, y, z;
constructing a tensor matrix based on the gradient vector:
$${T}_{grad} = {gg}^{T} = ( \begin{matrix}{g}_{1} {g}_{1} & {g}_{1} {g}_{2} & {g}_{1} {g}_{3} \\ {g}_{1} {g}_{2} & {g}_{2} {g}_{2} & {g}_{2} {g}_{3} \\ {g}_{1} {g}_{3} & {g}_{2} {g}_{3} & {g}_{3} {g}_{3}\end{matrix} )$$
performing characteristic decomposition on the tensor matrix to obtain GST characteristic attribute data:
$$T = {γ}_{1} {μμ}^{T} + {γ}_{2} {vv}^{T} + {γ}_{3} {ωω}^{T}$$
where, T represents GST characteristic attribute data, γ₁,γ₂,γ₃ represent three eigenvalues of T_{grad}, μ represents a unit bin in a transverse direction x, v represents a unit bin in a transverse direction y, and ω represents a unit bin in a longitudinal direction z.

6. The method according to claim 1, wherein extracting amplitude energy attribute data from the three-dimensional seismic data comprises:
extracting a seismic arc length attribute from the three-dimensional seismic data as amplitude energy attribute data based on a formula comprising:
$$S = \frac{1}{NT} {\sum }^{N} \sqrt{{[ a ( i + 1 ) - a ( i ) ]}^{2} + {T}^{2}}$$
where, S represents a single-channel seismic arc length extracted from the three-dimensional seismic data, T represents a calculation time window, N represents the number of sampling points in the time window and a(i) represents an amplitude value of an i-th sampling point in the time window.

7. The method according to claim 1, wherein extracting attenuation attribute data from the three-dimensional seismic data comprises:
extracting attenuation attribute data based on a formula comprising:
$$a = u {\vert}_{arctg \frac{{y}_{\_ 85} - {y}_{\_ 65}}{( {f}_{\_ 85} - {f}_{\_ 65} )}}$$
where, a represents attenuation attribute data, u represents a current seismic channel amplitude,
$$y = {\sum }_{0}^{n} {A}_{n}$$
represents total energy of seismic channels in the three-dimensional seismic data, f represents a frequency, which is a spectrum of the three-dimensional seismic data determined based on the seismic channel amplitude, y_₈₅ and f_₈₅ represent energy and frequency corresponding to 85% of the total energy, y_₆₅ and f_₆₅ represent energy and frequency corresponding to 65% of the total energy, n represents the number of sampling points and A represents an amplitude value.

8. An apparatus for predicting while drilling using seismic and drilling data in a target stratum, comprising:
a first obtainment module configured to obtain two-dimensional drilling data and two-dimensional logging data, and generate depth-domain geological stratification data based on the two-dimensional drilling data and the two-dimensional logging data;
a matching module configured to match the depth-domain geological stratification data with time-domain horizon data to construct a time-depth pairs dictionary;
a second obtainment module configured to obtain three-dimensional seismic data, and extract Gradient Structure Tensor (GST) characteristic attribute data, amplitude energy attribute data and attenuation attribute data from the three-dimensional seismic data;
an construction module configured to determine a first contribution degree corresponding to the GST characteristic attribute data, a second contribution degree corresponding to the amplitude energy attribute data and a third contribution degree corresponding to the attenuation attribute data, and construct initial seismic drilling data characterized by a multivariate and multi-type composite attribute;
a third obtainment module configured to obtain real-time two-dimensional data while drilling, and map the two-dimensional data while drilling into three-dimensional seismic data while drilling based on the time-depth pairs dictionary;
an update module configured to update the first contribution degree, the second contribution degree and the third contribution degree based on the three-dimensional seismic data while drilling; and
a generation module configured to obtain seismic and drilling prediction data of the target stratum represented by the multivariate and multi-type composite attribute based on an updated first contribution degree, an updated second contribution degree and an updated third contribution degree.

9. An electronic device comprising a processor and a memory which stores instructions executable by the processor, wherein when executing the instructions, the processor implements the steps of the method comprising:
obtaining two-dimensional drilling data and two-dimensional logging data, and generating depth-domain geological stratification data based on the two-dimensional drilling data and the two-dimensional logging data;
matching the depth-domain geological stratification data with time-domain horizon data to construct a time-depth pairs dictionary;
obtaining three-dimensional seismic data, and extracting Gradient Structure Tensor (GST) characteristic attribute data, amplitude energy attribute data and attenuation attribute data from the three-dimensional seismic data;
determining a first contribution degree corresponding to the GST characteristic attribute data, a second contribution degree corresponding to the amplitude energy attribute data and a third contribution degree corresponding to the attenuation attribute data, and constructing initial seismic drilling data characterized by a multivariate and multi-type composite attribute;
obtaining real-time two-dimensional data while drilling, and mapping the two-dimensional data while drilling into three-dimensional seismic data while drilling based on the time-depth pairs dictionary;
updating the first contribution degree, the second contribution degree and the third contribution degree based on the three-dimensional seismic data while drilling; and
obtaining seismic and drilling prediction data of the target stratum characterized by the multivariate and multi-type composite attribute based on an updated first contribution degree, an updated second contribution degree and an updated third contribution degree.

10. The electronic device according to claim 9, wherein the initial seismic drilling data characterized by the multivariate and multi-type composite attribute is expressed as a formula comprising:
$${R}^{1} = f ( λ ) = A \cdot {λ}_{1}^{1} + B \cdot {λ}_{2}^{1} + C \cdot {λ}_{3}^{1}$$
where, R¹ represents the initial seismic drilling data, A represents the GST characteristic attribute data, B represents the amplitude energy attribute data, C represents the attenuation attribute data, λ₁¹ represents an initial first contribution degree, λ₂¹ represents an initial second contribution degree and λ₃¹ represents an initial third contribution degree.

11. The electronic device according to claim 10, wherein updating the first contribution degree, the second contribution degree and the third contribution degree based on the three-dimensional seismic data while drilling comprises:
constructing an objective function comprising:
$$E ( λ ) = {‖ {D}^{n} - f ( {λ}^{n} ) ‖}_{2}^{2}$$
where, Dⁿ represents the lithological interpretation data derived from well logging data after an n-th update, and f(λⁿ)=Rⁿ=A·λ₁ⁿ+B·λ₂ⁿ+C·λ₃ⁿ represents the three-dimensional seismic data while drilling characterized by the multivariate and multi-type composite attribute after the n-th update;
solving the objective function using a formula comprising:
$$λ = {( {S}^{T} S )}^{- 1} {S}^{T} D$$
where, λ represents the first contribution degree, the second contribution degree and the third contribution degree, S represents an l×3 matrix composed of characteristic parameters of the three types of attribute data, and D represents the updated lithological interpretation data of the l×3 matrix; and
taking a solved first contribution degree, a solved second contribution degree and a solved third contribution degree as the updated first contribution degree, the updated second contribution degree and the updated third contribution degree.

12. The electronic device according to claim 9, wherein matching the depth-domain geological stratification data with time-domain horizon data to construct a time-depth pairs dictionary comprises:
matching a medium stratification initial position through the geological stratification depth domain data and time-domain horizon data to obtain an initial mapping relationship; and
performing a time-depth conversion based on logging data of an adjacent target stratum and a predicted target stratum average velocity to construct a time-depth pairs dictionary.

13. The electronic device according to claim 9, wherein extracting Gradient Structure Tensor (GST) characteristic attribute data from the three-dimensional seismic data comprises:
obtaining a gradient vector by calculating first-order partial derivatives of any point u in the three-dimensional seismic data in three directions:
$$g = ∇ u ( x , y , z ) = [ \begin{matrix}\frac{\partial u ( x , y , z )}{\partial x} \\ \frac{\partial u ( x , y , z )}{\partial y} \\ \frac{\partial u ( x , y , z )}{\partial z}\end{matrix} ] = {( {g}_{1} , {g}_{2} , {g}_{3} )}^{T}$$
where, g represents a gradient vector of any point u in the three-dimensional seismic data, and g₁,g₂,g₃ represent partial derivatives of any point u in the three-dimensional seismic data in three directions x, y, z;
constructing a tensor matrix based on the gradient vector:
$${T}_{grad} = {gg}^{T} = ( \begin{matrix}{g}_{1} {g}_{1} & {g}_{1} {g}_{2} & {g}_{1} {g}_{3} \\ {g}_{1} {g}_{2} & {g}_{2} {g}_{2} & {g}_{2} {g}_{3} \\ {g}_{1} {g}_{3} & {g}_{2} {g}_{3} & {g}_{3} {g}_{3}\end{matrix} )$$
performing characteristic decomposition on the tensor matrix to obtain GST characteristic attribute data:
$$T = {γ}_{1} {μμ}^{T} + {γ}_{2} {vv}^{T} + {γ}_{3} {ωω}^{T}$$
where, T represents GST characteristic attribute data, γ₁,γ₂,γ₃ represent three eigenvalues of T_{grad}, μ represents a unit bin in a transverse direction x, v represents a unit bin in a transverse direction y, and ω represents a unit bin in a longitudinal direction z.

14. The electronic device according to claim 9, wherein extracting amplitude energy attribute data from the three-dimensional seismic data comprises:
extracting a seismic arc length attribute from the three-dimensional seismic data as amplitude energy attribute data based on a formula comprising:
$$S = \frac{1}{NT} {\sum }^{N} \sqrt{{[ a ( i + 1 ) - a ( i ) ]}^{2} + {T}^{2}}$$
where, S represents a single-channel seismic arc length extracted from the three-dimensional seismic data, T represents a calculation time window, N represents the number of sampling points in the time window and a(i) represents an amplitude value of an i-th sampling point in the time window.

15. The electronic device according to claim 9, wherein extracting attenuation attribute data from the three-dimensional seismic data comprises:
extracting attenuation attribute data based on a formula comprising:
$$a = u {\vert}_{arctg \frac{{y}_{\_ 85} - {y}_{\_ 65}}{( {f}_{\_ 85} - {f}_{\_ 65} )}}$$
where, a represents attenuation attribute data, u represents a current seismic channel amplitude,
$$y = {\sum }_{0}^{n} {A}_{n}$$
represents total energy of seismic channels in the three-dimensional seismic data, f represents a frequency, which is a spectrum of the three-dimensional seismic data determined based on the seismic channel amplitude, y_₈₅ and f_₈₅ represent energy and frequency corresponding to 85% of the total energy, y_₆₅ and f_₆₅ represent energy and frequency corresponding to 65% of the total energy, n represents the number of sampling points and A represents an amplitude value.
